(19) United States
(12) Patent Application Publication
(10) Pub. No.: US 2005/0235968 A1
(43) Pub. Date: Oct. 27, 2005

(54) Fuel vapor recovery system

(76) Inventors: Mahlon R. Pachciarz, Grand Blanc, MI (US); Gary F. Stack, Fenton, MI (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/832,041

(22) Filed: Apr. 26, 2004

(51) Int. Cl. F02M 33/02

(52) U.S. Cl. 123/519

(57) ABSTRACT

A fuel vapor recovery system for a fuel tank of a vehicle includes a vapor canister fluidly communicating with an interior chamber of the fuel tank to adsorb fuel vapor. The fuel vapor recovery system also includes a check valve adapted to be disposed in the fuel tank and adapted to be fluidly interconnected with the vapor canister and the fuel tank to allow one-way flow of fuel vapor from the interior chamber to the vapor canister.

### TECHNICAL FIELD

The present invention relates generally to fuel vapor recovery systems for vehicles and, more particularly, to a fuel vapor recovery system for a fuel tank of a vehicle.

### BACKGROUND OF THE INVENTION

It is known to provide a fuel system for a vehicle having a fuel tank to hold fuel to be used by an engine of the vehicle. It is also known to provide a fuel vapor recovery system for the fuel tank of the vehicle. Typically, the fuel vapor recovery system includes a vapor canister remotely mounted such as in an engine compartment of the vehicle and operatively connected by separate external valves and lines to the fuel tank.

Currently, fuel systems utilize what is considered an “open vent” fuel vapor recovery system to meet onboard refueling vapor recovery regulations. These fuel systems are also tied to vehicle onboard diagnostics in which the vehicle self checks for leaks within the fuel system.

It is known to provide a fuel limiting vent valve (FLVV) and a roll over or grade vent valve (GVV) for a fuel vapor recovery system. These valves have liquid discriminating properties for the fuel system, affecting fill quality and vent capability. The FLVV controls an initial shutoff of a refilling pump at a fuel service station. This valve has a very high flow rate capability with low restriction. The GVV has a significant reduction in orifice size and typically controls the fill capacity of the fuel tank to 100-104% during the next two attempts of filing the fuel tank by pulling a fill nozzle handle of the refilling pump. However, one disadvantage is the ability of the fuel system to trickle fill beyond the 104% level. This potential over stuffing of the fuel tank can cause problems for some fuel systems.

Some fuel systems have used a dual stage grade vent valve (DSGVV) in place of the GVV in order to further restrict the flow of venting vapor after the FLVV has caused the initial shutoff. While this has improved the trickle fill condition, the introduction of the DSGVV has been at a significant cost disadvantage.

Therefore, it is desirable to provide a fuel vapor recovery system that eliminates trickle fills to the fuel tank. It is also desirable to provide a fuel vapor recovery system that reduces or eliminates liquid discrimination through a grade vent valve or dual stage grade vent valve. It is further desirable to provide a fuel vapor recovery system that eliminates trickle fills to the fuel tank at a reduced cost. Therefore, there is a need in the art to provide a fuel vapor recovery system that meets these desires.

### SUMMARY OF THE INVENTION

Accordingly, the present invention is a fuel vapor recovery system for a fuel tank of a vehicle including a vapor canister fluidly communicating with an interior chamber of the fuel tank to adsorb fuel vapor. The fuel vapor recovery system also includes a check valve adapted to be disposed in the fuel tank and adapted to be fluidly interconnected with the vapor canister and the fuel tank to allow one-way flow of fuel vapor from the interior chamber to the vapor canister.

One advantage of the present invention is that a new fuel vapor recovery system is provided for a fuel tank of a vehicle that eliminates trickle fills to the fuel tank. Another advantage of the present invention is that the fuel vapor recovery system replaces a normally open GVV or DSGVV with a normally closed check valve similar to ones used for fuel lines. Yet another advantage of the present invention is that the fuel vapor recovery system reduces or eliminates liquid discrimination for the fuel system by using a normally closed check valve. Still another advantage of the present invention is that the fuel vapor recovery system has a normally closed check valve that is smaller in size than a GVV or DSGVV, allowing the check valve to be located higher in the fuel tank. A further advantage of the present invention is that the fuel vapor recovery system reduces cost by incorporating a normally closed check valve in place of a normally open GVV or DSGVV.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a diagrammatic view of a fuel vapor recovery system for a fuel tank, according to the present invention.

### DESCRIPTION OF THE PREFERRED EMBODIMENT

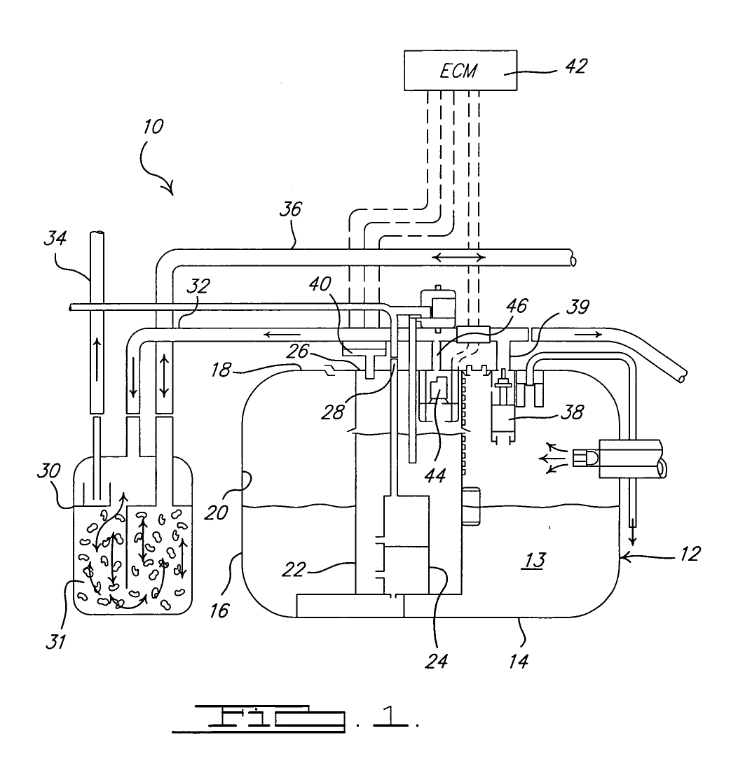

Referring to the drawings and in particular FIG. 1, one embodiment of a fuel vapor recovery system 10, according to the present invention, is shown for a fuel tank, generally indicated at 12, for a vehicle (not shown). The fuel tank 12 holds liquid fuel 13 therein. In this embodiment, the fuel tank 12 includes a bottom or base wall 14 and a side wall 16 around a periphery of the base wall 14 and extending generally perpendicular thereto. The fuel tank 12 also includes a top wall 18 extending generally perpendicular to the side wall 16 to form an interior chamber 20. The fuel tank 12 is made of a rigid material, preferably a plastic material. It should be appreciated that the fuel tank 12 could be made of a metal material such as steel.

The fuel tank 12 includes a fuel pump module 22 disposed in the interior chamber 20. The fuel pump module 22 contains a pump 24 and a mechanism (not shown) for measuring fuel level in the interior chamber 20 of the fuel tank 12. The fuel pump module 22 has a cover 26 that has at least one tube 28 for liquid fuel and an opening (not shown) for an electrical pass-through. It should be appreciated that the fuel pump module 22 is conventional and known in the art.

The fuel vapor recovery system 10 also includes a vapor canister 30 holding a canister bed 31 to adsorb hydrocarbon or fuel vapor while allowing air to pass to and from the fuel tank 12. The vapor canister 30 has a first tube 32 for communicating with the fuel tank 12, a second tube 34 communicating with and being purged by an engine (not shown) and a third tube 36 communicating with the outside environment. It should be appreciated that the vapor canister 30 is conventional and known in the art.

The fuel vapor recovery system 10 includes a fill limiting vent valve (FLVV) 38 to seal the system for testing system leakage. The vent valve 38 is disposed in the fuel tank 12 and operatively supported by the cover 26. The vent valve 38 is connected by a hose or conduit 39 to the first fuel tube 32. The fuel vapor recovery system 10 includes a tank vacuum sensor 40 connected to the fuel tank 12 for sensing the pressure of the fuel to determine how well the system 10 maintains vacuum once the vent valve 38 has been closed. It should be appreciated that the sensor 40 is electrically connected to an electronic controller or control module 42, which is conventional and known in the art.

The fuel vapor recovery system 10 also includes a check valve 44 interconnecting the fuel tank 12 and the vapor canister 30. In the embodiment illustrated, the check valve 44 is disposed in the fuel tank 12 and operatively supported by the cover 26. The check valve 44 is connected by a hose or conduit 46 to the first tube 32. The check valve 44 is normally closed and opens at a predetermined pressure such as from approximately 3.0 kPa to approximately 3.5 kPa to allow fuel vapor and air from the fuel tank 12 to communicate with the vapor canister 30. The check valve 44 is of a conventional type similar to that used for fuel lines. It should be appreciated that the check valve 44 replaces a normally open grade vent valve or dual stage grade vent valve.

In operation, engine vacuum is used to draw a vacuum on the fuel vapor recovery system 10. The valves are closed to seal the vacuum in the vapor canister 30 and fuel tank 12. The system 10 is closed only for a short period of time. As the vehicle is driven, the fuel level in the fuel tank 12 drops and the vent valve 38 opens, making the system 10 a normally open system. If purge occurs prior to the vent valve 38 opening, the vacuum is greater than the predetermined pressure for opening the check valve 44 and the check valve 44 opens, allowing the system 10 to purge. The vapor canister 30 holds the fuel vapor, allowing fairly clean air to pass into and out of the fuel tank 12. It should be appreciated that California regulations relative to less than 2.5 kPa pressure build in the fuel tank 12 is relative to a test only at a 40% tank fill in which the vent valve 38 is normally open and the system 10 does not come close to that level. It should also be appreciated that removing a fuel cap (not shown) for refueling means the fuel tank 12 is usually significantly less than full and the vent valve 38 is open. It should further be appreciated that the purging of fuel vapor is conventional and known in the art.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A fuel vapor recovery system for a fuel tank of a vehicle comprising:
a vapor canister fluidly communicating with an interior chamber of the fuel tank to adsorb fuel vapor; and
a check valve adapted to be disposed in the fuel tank and adapted to be fluidly interconnected with said vapor canister and the fuel tank to allow one-way flow of fuel vapor from the interior chamber to said vapor canister.

2. A fuel vapor recovery system as set forth in claim 1 wherein said vapor canister includes a first tube fluidly communicating with atmosphere and a second tube fluidly communicating with said interior chamber.

3. A fuel vapor recovery system as set forth in claim 2 including a fill limiting vent valve disposed in the fuel tank and fluidly connected to said first tube.

4. A fuel vapor recovery system as set forth in claim 2 wherein said check valve is disposed in the fuel tank and fluidly connected to said first tube.

5. A fuel vapor recovery system as set forth in claim 3 wherein said check valve is located between said vapor canister and said vent valve.

6. A fuel vapor recovery system as set forth in claim 1 wherein said check valve is normally closed.

7. A fuel vapor recovery system for a vehicle comprising:
a fuel tank having an interior chamber;
a vapor canister fluidly communicating with said interior chamber of said fuel tank to adsorb fuel vapor; and
a normally closed check valve disposed in said fuel tank and fluidly interconnecting said vapor canister and said fuel tank to allow one-way flow of fuel vapor from said interior chamber to said vapor canister.
